(19) United States
(12) Patent Application Publication
(10) Pub. No.: US 2006/0065795 A1
(43) Pub. Date: Mar. 30, 2006

(54) Support for flat monitors

(75) Inventor: Nicholas L. Blackburn, Wellesley (CA)

Correspondence Address: DARYL W SCHNURR;MILLER THOMSON LLP, PO BOX 578, SUITE 700, 22 FREDERICK STREET, KITCHENER, ON, N2G 4A2, CA

(73) Assignee: CompX International

(21) Appl. No.: 11/239,045

(22) Filed: Sep. 30, 2005

Related U.S. Application Data
(60) Provisional application No. 60/614,047, filed on Sep. 30, 2004.

(51) Int. Cl. F16M 11/00; A47F 5/00

(52) U.S. Cl. 248/122.1

(57) ABSTRACT

A support for a plurality of flat monitors has a plurality of support arms. Some of the support arms have a curved body and the support arms are connectable to a main support so that several monitors can be supported at the same height whether the main support is horizontal or vertical. Ball lock joints are used as the connectors between the support arms. A method of constructing a support, the appropriate combination of support arms and connectors are chosen to construct a monitor with the desired number of monitor supports.

Priority is claimed based upon U.S. Provisional Application Ser. No. 60/614,047 filed on Sep. 30, 2004.

### BACKGROUND OF THE INVENTION

1. Field of the Invention

This invention relates to a flat monitor support having a plurality of supports with a curved body and two ends, said ends being located at different levels when said ends are substantially horizontal. This invention further relates to a method of constructing a support for a plurality of flat monitors.

2. Description of the Prior Art

It is known to have flat monitor supports. One support is used to support a plurality of flat monitors. However, with previous supports, the supports are often inflexible in that the number of monitors that are supportable by the support is not easily varied, or the supports do not support the monitors at the same height or level, or the configuration of this support is not variable or, the support does not contain ball lock joints interconnecting the support arms, or, the support arms are not identical to one another, or the support arms are not interchangeable, or the support arms cannot be connected to one another at either end in either an upright position or inverted position. It is much more comfortable for a user to read information on monitors that mounted side by side at the same height. With previous flat monitor supports, particularly when a main support is vertically oriented, the monitors are supported at different heights. Further, with previous monitors, a configuration of the support cannot be easily varied.

### SUMMARY OF THE INVENTION

It is an object of the present invention to provide a flat monitor support for supporting a plurality of monitors where the support can be easily reconfigured to increase or decrease the number of monitors and can support all of the monitors at the same height, even though the number of extension arms may vary or support arms may not be connected at the same height.

It is a further object of the present invention to provide a monitor support for supporting flat monitors where the support has support arms that are pivotally connected to one another through ball lock joints that are readily removable and replaceable.

A support for a plurality of flat monitors comprises a plurality of support arms. At least some the supports arms have a curved body with a first end and a second end. The ends each have an opening therein to receive a connector. The ends are pivotally connected about any connector located within said ends. The first end is located at a higher level than the second end when the ends are substantially oriented in horizontal planes. The support is capable of supporting all of the flat monitors at an identical height. The support arms are connectable to a main support and to one another. There are sufficient support arms supporting each monitor to support all of the monitors at an identical height.

A support for a plurality of flat monitors comprises a plurality of support arms. The support arms have a first end and a second end. Each of the ends has an opening therein to receive a connector, there being a plurality of connectors. At least one of the connectors is a ball lock joint that is sized and shaped to removably fit within any one of said openings. The at least one ball lock joint has a locked position and an unlocked position, the support arms being pivotal about the at least one ball lock joint when the at least one ball lock joint is in the locked position.

A method of constructing a support for a plurality of flat monitors has a main support with a plurality of first support arms. The first support arms have a curved body with a first end and a second end, the curved body extending in a vertical plane. The ends each have an opening therein to receive a connector and are capable of being pivotally connected to the connector. There are a plurality of connectors and a plurality of second support arms, the second support arms being straight support arms with monitor attachments at free ends thereof. The method comprises choosing an appropriate combination of first support arms and connectors from the plurality of first arms, second arms and connectors and connecting the support arms to the main support and/or to one another, with second support arms being added to the first support arms where necessary to achieve a monitor support for a desired number of monitors having free ends that are at a desired height.

### BRIEF DESCRIPTION OF THE DRAWINGS

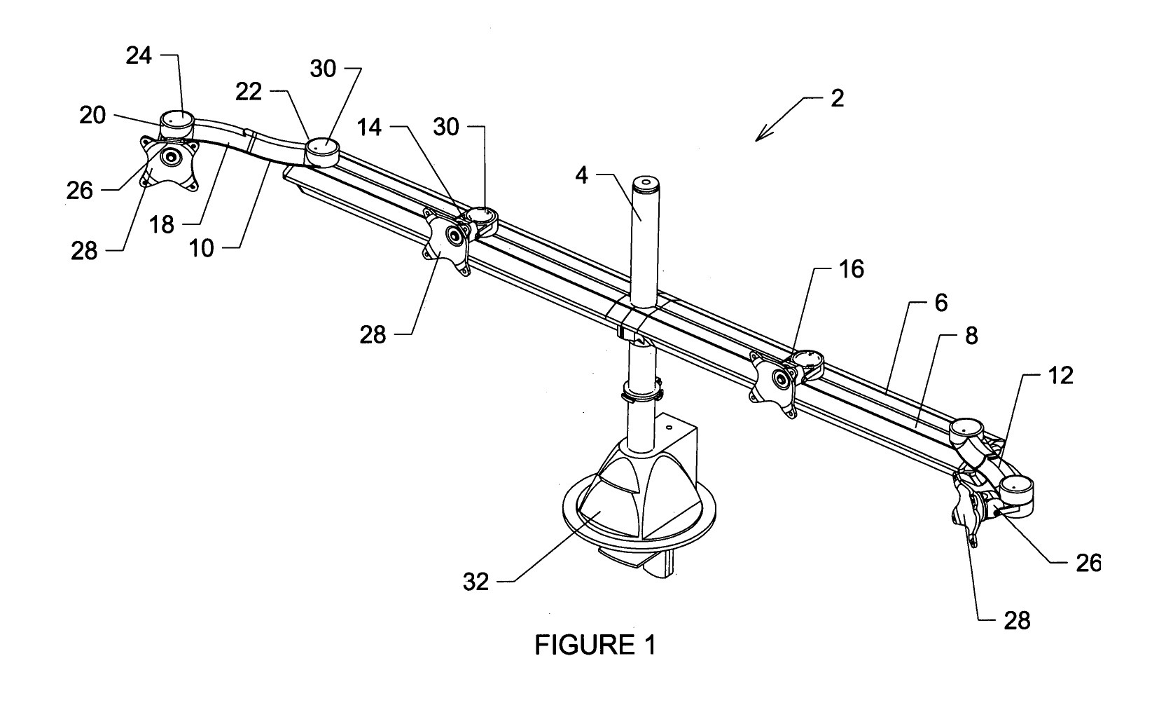

In FIG. 1, there is shown a perspective view of a support for four flat monitors;

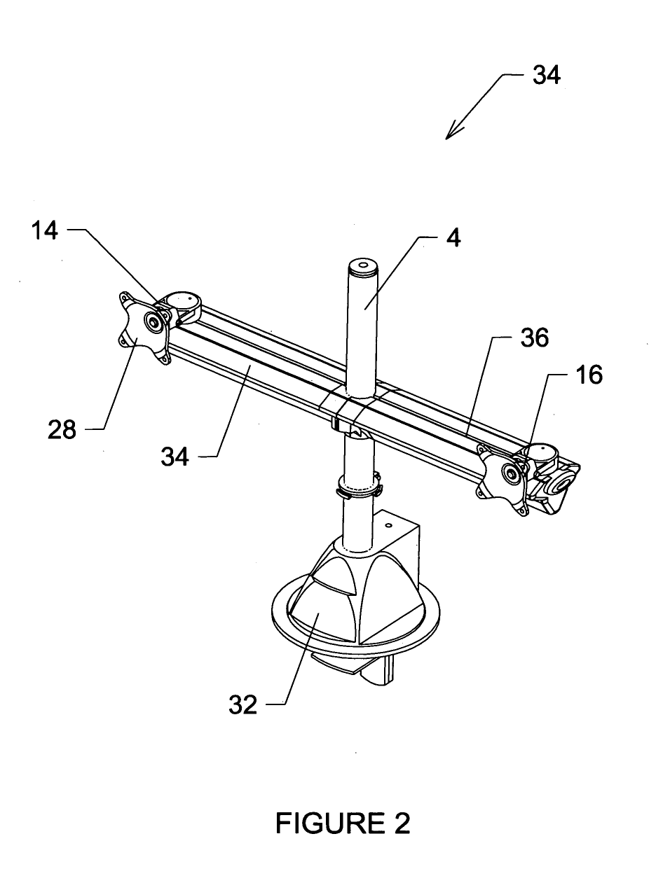

In FIG. 2, there is shown an assembly to support two flat monitors;

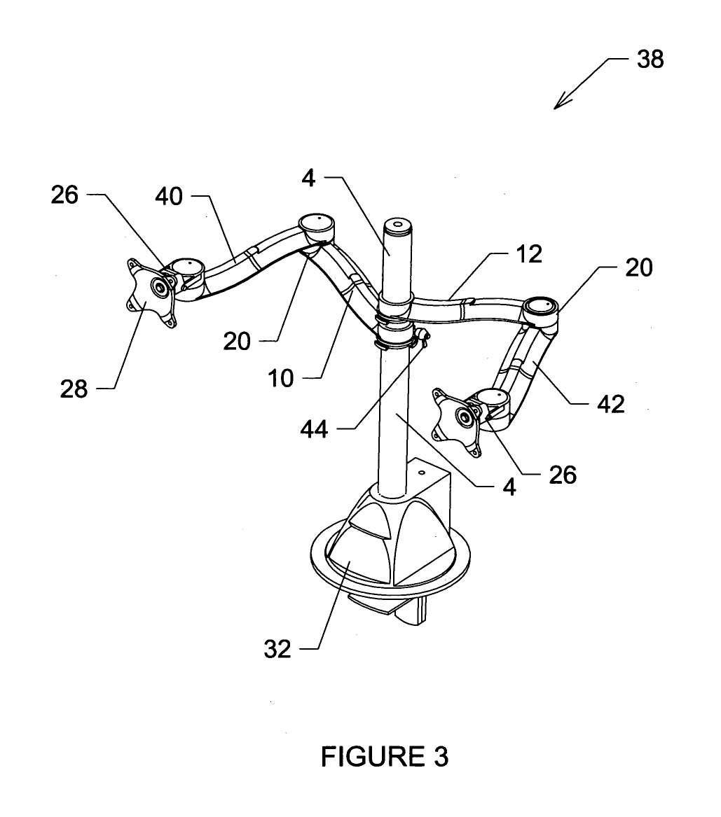

In FIG. 3, there is shown a perspective view of a support having an extension assembly for supporting two flat monitors;

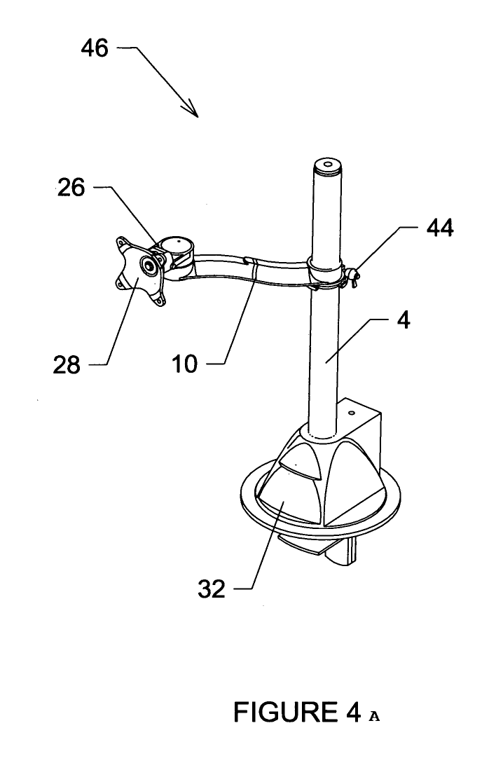

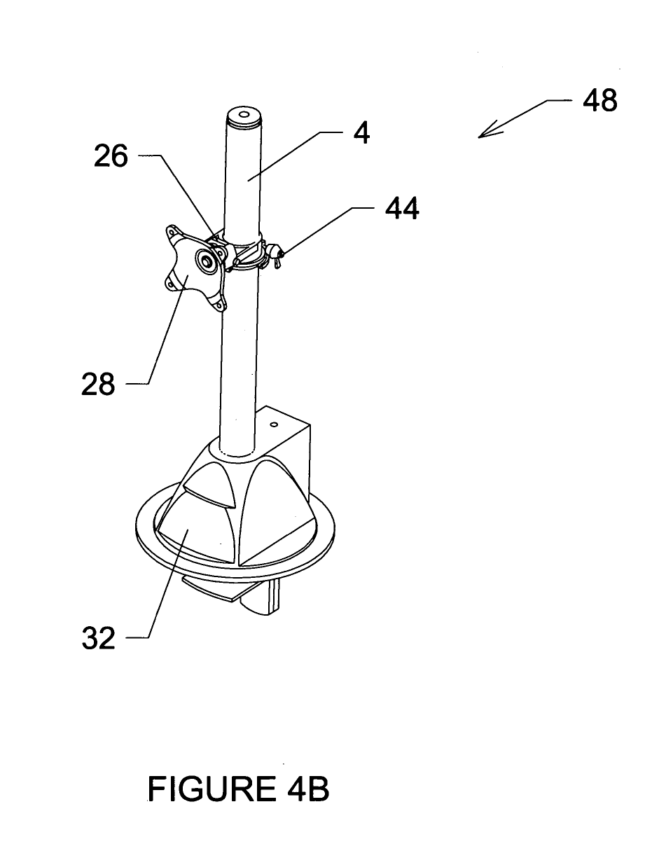

In FIG. 4A, there is shown a support that is configured to support one flat monitor;

In FIG. 4B, there is shown a further embodiment of a support that is configured to support one flat monitor;

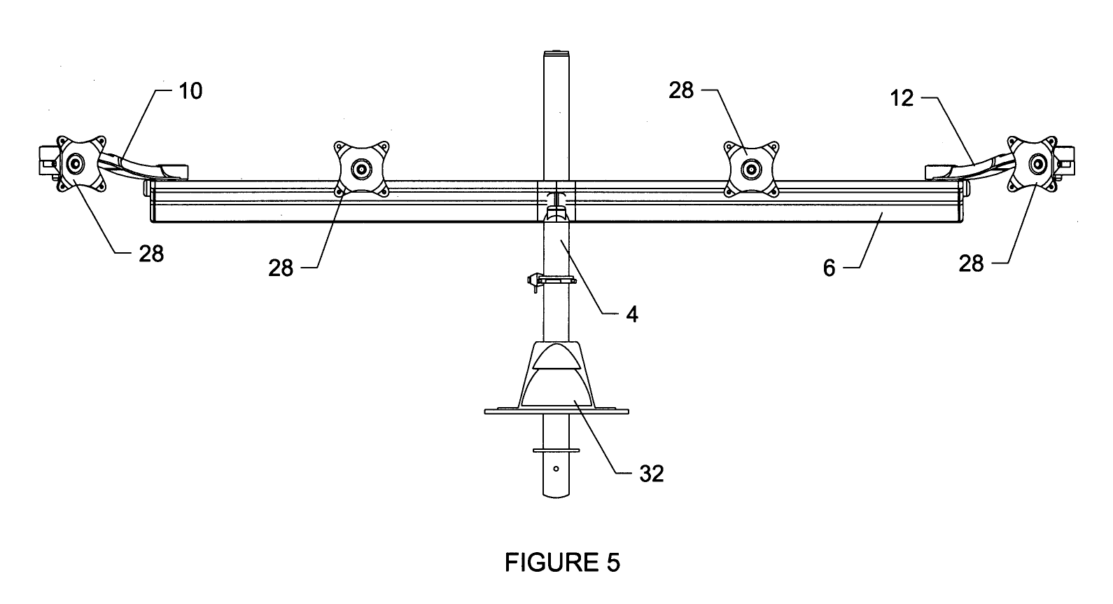

In FIG. 5, there is shown a front view of the support of FIG. 1;

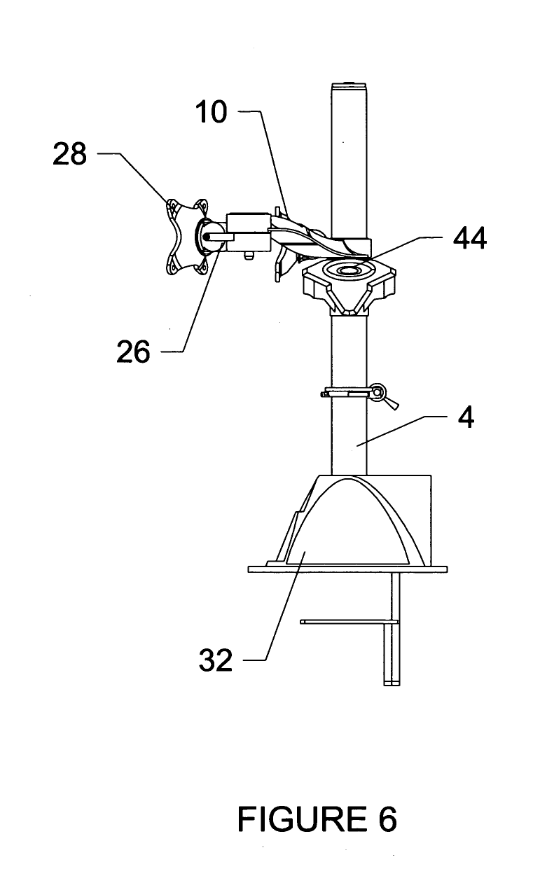

In FIG. 6, there is shown a side view of the support of FIG. 1;

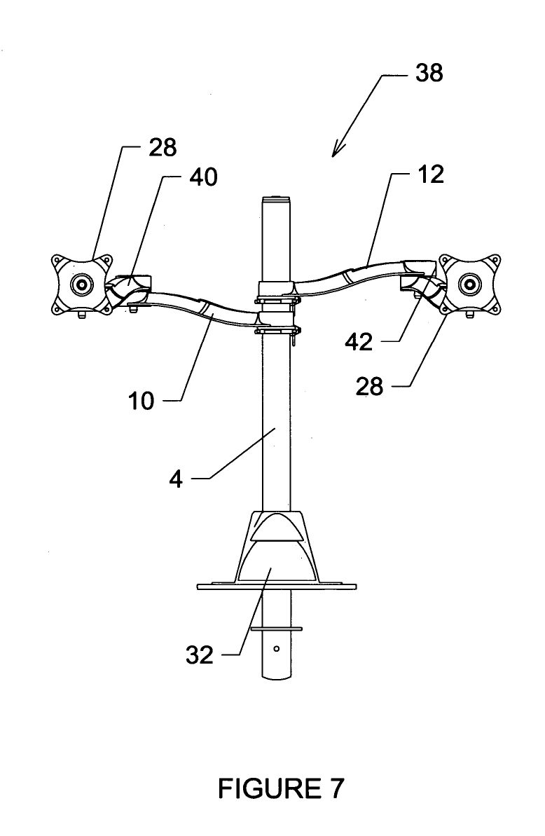

In FIG. 7, there is shown a front view of the support shown in FIG. 3;

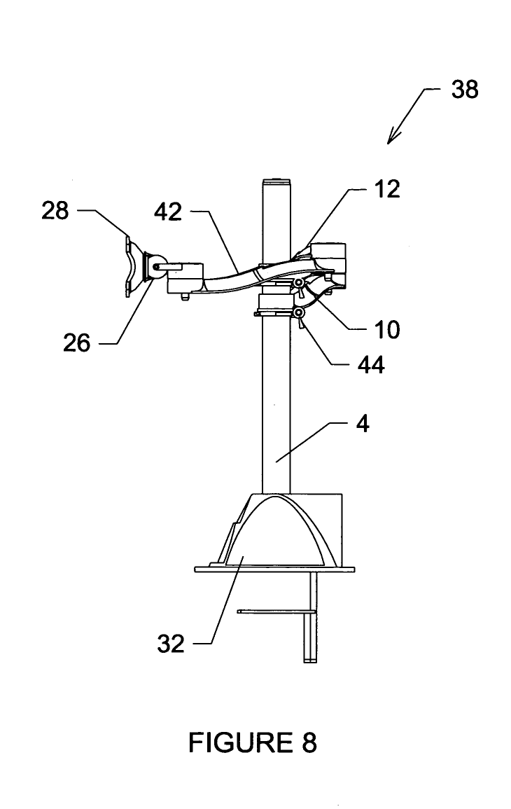

In FIG. 8, there is shown a side view of the support shown in FIG. 7;

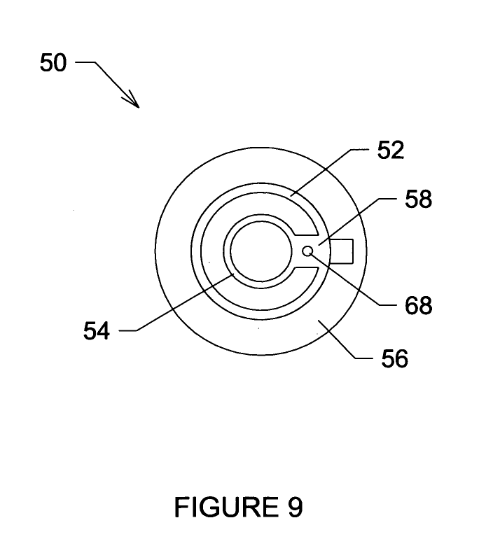

In FIG. 9, there is shown a top view of a cylinder of a ball lock joint;

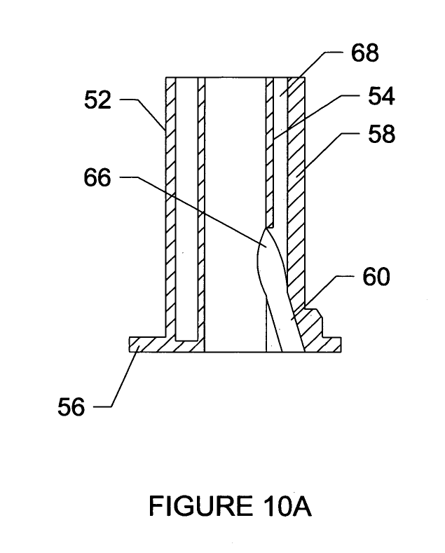

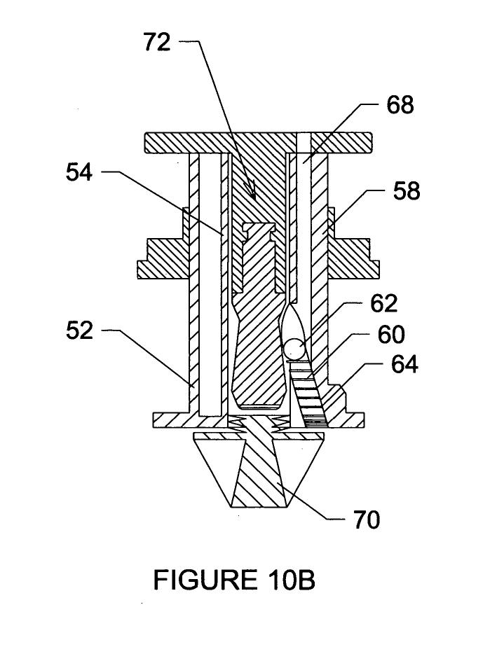

In FIG. 10A, there is shown a sectional side view of a cylinder of a ball lock joint;

In FIG. 10B, there is shown a sectional side view of the cylinder of the ball lock joint with a ball bearing in an angular passage;

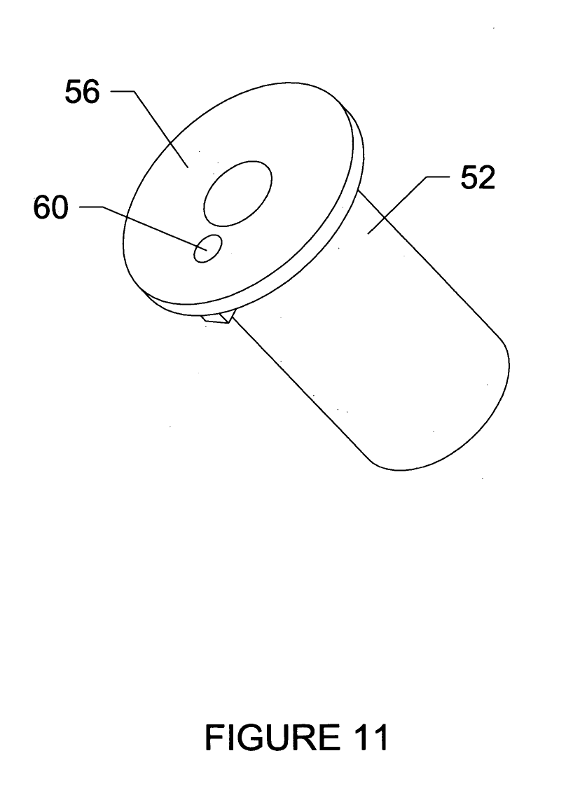

In FIG. 11, there is shown a perspective view of a cylinder of a ball lock joint when viewed from a bottom;

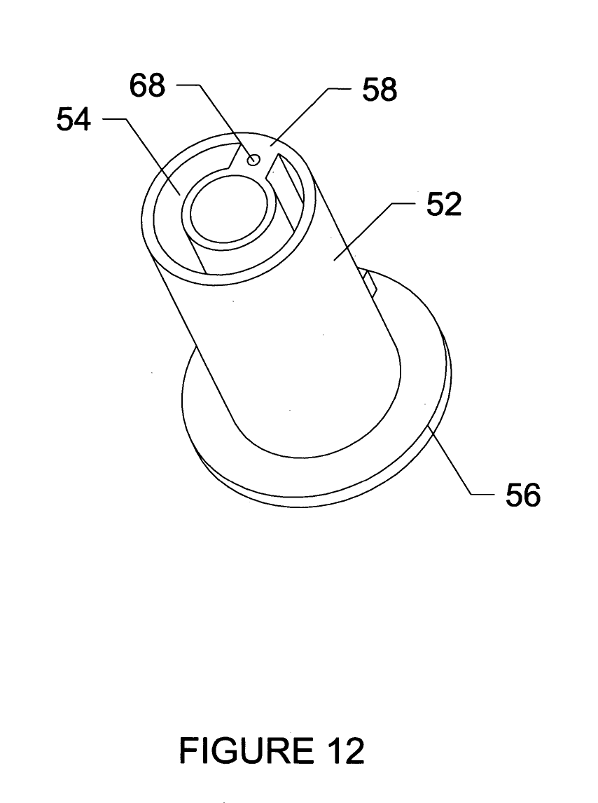

In FIG. 12, there is shown a perspective view of a cylinder of a ball lock joint when viewed from a top;

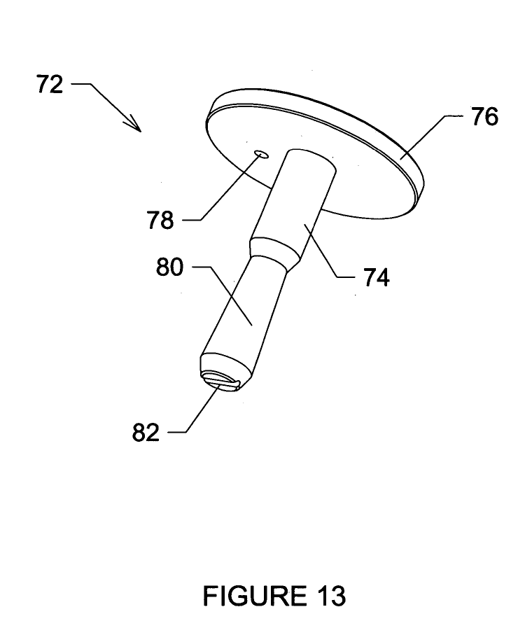

In FIG. 13, there is shown a perspective view of a spindle of a ball lock joint when viewed from a bottom;

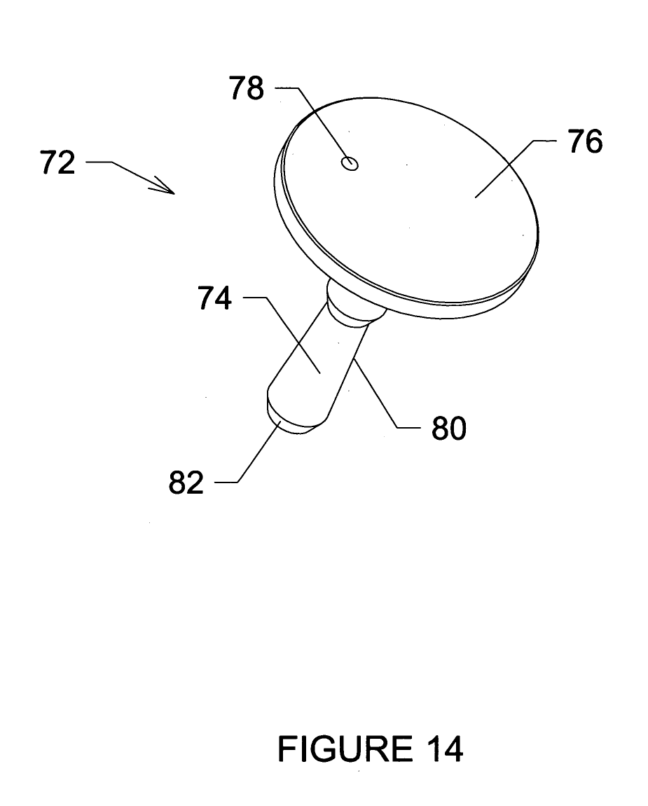

In FIG. 14, there is shown a perspective view of a spindle when viewed from a top;

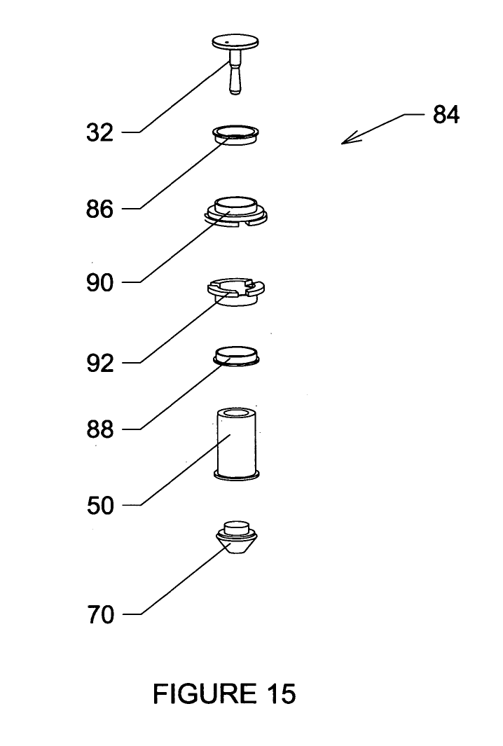

In FIG. 15, there is shown an exploded perspective view of a ball lock joint;

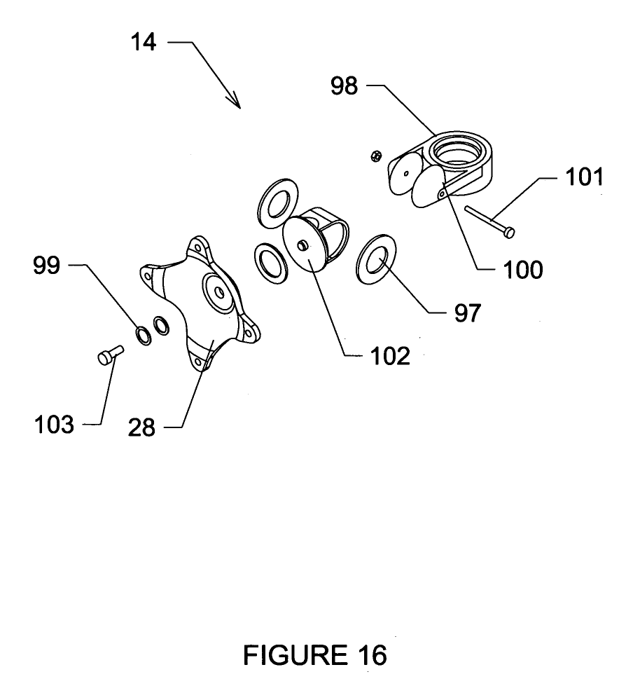

In FIG. 16, there is shown an exploded perspective view of a straight arm support;

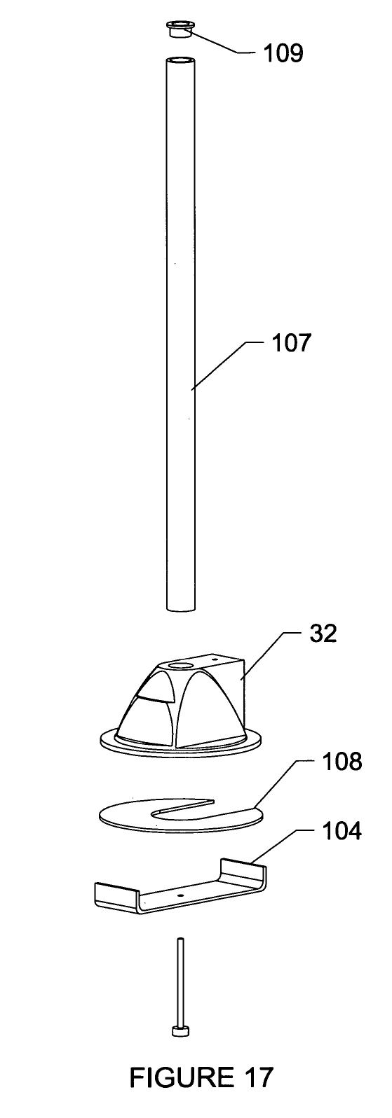

In FIG. 17, there is shown an exploded perspective view of a main support having a grommet mount option;

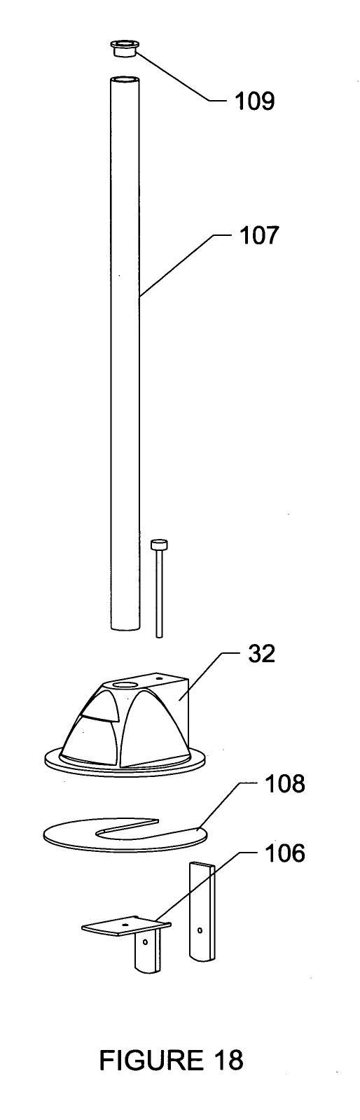

In FIG. 18, there is shown exploded perspective view of a main support having a clamp mount option;

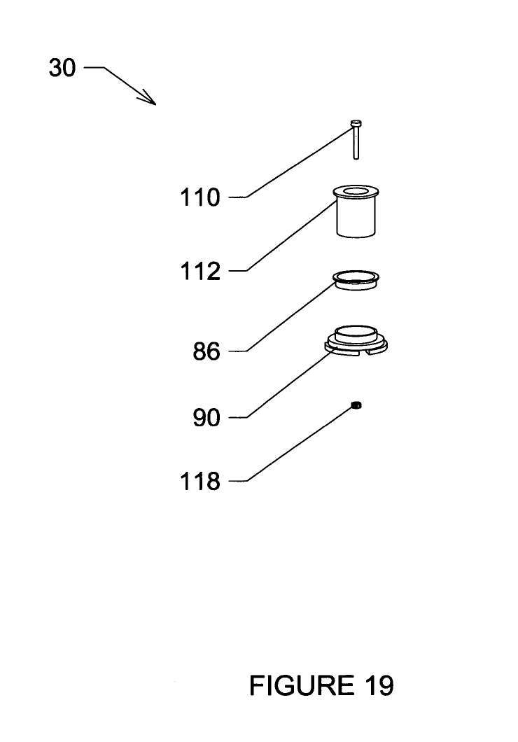

In FIG. 19, there is shown an exploded perspective view of a beam joint;

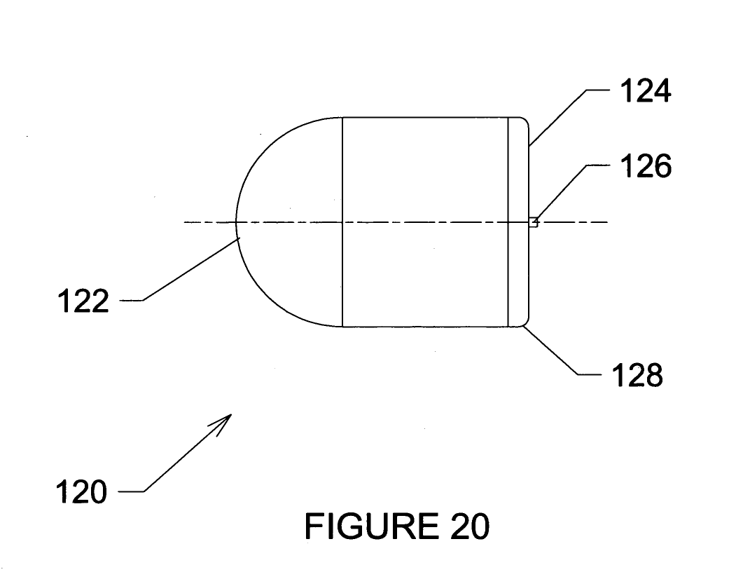

In FIG. 20, there is shown a side view of a ball lock pin; and

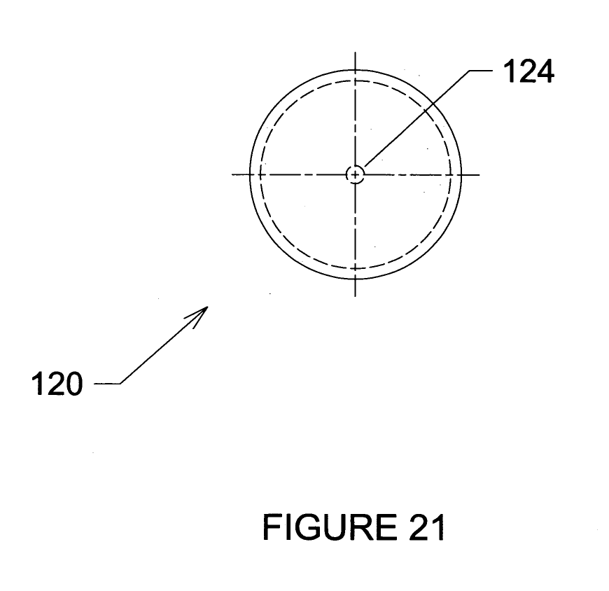

In FIG. 21, there is shown a front view of the ball lock pin.

### DETAILED DESCRIPTION OF A PREFERRED EMBODIMENT

In FIG. 1, a support 2, for flat monitors (not shown) has a main support 4 with a horizontal beam 6 being supported thereby. The beam 6 has a longitudinal channel 8 located therein. There are two first support arms 10, 12 and two second arms 14, 16.

The first support arms 10, 12 are curved support arms and each has a curved body 18 with two ends 20, 22. the curved body is oriented to extend in a vertical plane when installed on said support.

The two ends 20, 22 are located at different levels when the curved body 18 lies substantially in a horizontal plane. The ends 20, 22 each have an opening therein to receive a connector. The end 20 has a ball lock joint 24, which pivotally connects the arm 10 to a straight support arm 26. The straight arm 26 has a monitor attachment 28 mounted thereon. The opening at the end 22 of the support arm 10 is pivotally connected to the beam 6 by a beam joint 30 that is mounted on the beam 6 through the channel 8. The ball lock joint 24 and the beam joint 30 are connectors. The same reference numerals are used for the components of the first support arm 12 as those used for the first support arm 10.

The second support arms 14, 16, are straight supports and have an opening at one end that is pivotally connected through a beam joint 30 to the beam 6 in the same manner that the first support arms 10, 12 are connected to the beam 6. The second support arms 14, 16 are straight supports and are identical to the straight arm support 26, which can also be described as a second support arm. The curved support arms are described as first supports and the straight support arms are described as second supports. The second support arms 14, 16 also have monitor attachments 28 mounted thereon. The monitor attachment 28 is mounted in such a manner that the monitor (not shown) on each attachment can be tilted in various directions. The main support 4 has a base 32 thereon.

In FIG. 2, there is shown a perspective view of a support 0.34 for two flat monitors (not shown). In FIG. 2, the main support 4 has a horizontal beam 36 mounted thereon. The horizontal beam 36 has the same design as the horizontal beam 6, but is much shorter than the beam 6. There are two second supports 14, 16 mounted on the beam 36. The same reference numerals are used for FIG. 2 to describe those components that identical to the components in FIG. 1.

In FIG. 3, there is shown a further embodiment of a support 38 for two flat monitors (not shown). The support 38 differs from the support 34 in that the support 38 has two first support arms 10, 12 connected directly to the main support 4. In addition, there are two additional first support arms 40, 42. The support arm 40 is connected to the end 20 of the support arm 10 and the support arm 42 is connected to the end 20 of the support arm 12. Each support arm 40, 42 has a second support arm 26 and monitor attachment connected thereto. The support arms 10, 12 each have a locking lever 44 thereon to lock the support at a particular height on the main support 4. The support arms 10, 12, 40, 42 are all first support arms and are all identical to one another. When the locking levers are in the unlocked position, the support arms can be moved upward or downward or pivoted about the main support 4. When the locking levers are tightened to the locked position, the arms 10, 12 are in a fixed position on the main support 4. Obviously, the arms 10, 12 must be at different heights on the main support 4. However, even though the arms are mounted at different heights on the main support 4, the monitor attachments can be located at the identical height in one horizontal plane. It can be seen that the first support arm 40 is mounted above the first support arm 10 and the first support arm 10 is located beneath the first support arm 12. Further, the first support arm 42 is mounted beneath the first support arm 12 so that the height of the two monitor attachments 28 will be identical. The same reference numerals are used in FIG. 3 to describe those components that are identical to the components of FIG. 1.

In FIG. 4A, there is shown a perspective view of a support 46 having a first support arm 10 connected to the main support 4 and a second support arm 26 connected to the first support arm.

In FIG. 4B, a support 48 has a second support arm 26 connected directly to the main support 4. The support arm 26 has a locking lever 44 connected thereto to lock or unlock the second support arm 26 on the main support 4. The support 46 could be reconfigured to add a second support arm 26 and monitor attachment 28 (not shown) that is identical to the arrangement shown and the two attachments could be located at the same height. With the support 48, if a second attachment and straight support arm is added to the support 48, the two attachments will be at different heights. The same reference numerals are used in FIG. 4A to describe those components that are identical to the components in FIG. 3.

In FIGS. 5 and 6, the same reference numerals are used to describe those components that are identical to the components in FIG. 1. From FIGS. 5 and 6, it can be seen that the monitor attachments 28 are at the same height for all of the attachments of the support 2.

The same references are used in FIGS. 7 and 8 as those used in FIG. 3 for those components that are identical. In FIGS. 7 and 8, it can be seen that the monitor attachments 28 are the same height for both attachments even though the support arms 10, 12 are mounted at a different height on the main support 4. The additional support arms can be mounted above or beneath the previous support arm depending on the desired height for the attachments.

In FIGS. 9, 10A, 10B, 11 and 12, there is shown a housing 50 having an outer cylinder 52 and inner cylinder 54 that are concentrically mounted relative to one another on a base 56. The two cylinders, 52, 54 are interconnected by a web 58 extending between them. An angular passage 60 extends from the base 56 to the inner cylinder 54. The angular passage contains a ball bearing 62 mounted on a spring 64, which biases the ball bearing toward the inner cylinder 54 so that, in a locked position, the ball bearing will proceed partially into the inner cylinder 54 through an opening 66. A vertical passage 68 extends between an upper surface of the web 58 and the angular passage 60. The vertical passage is smaller in size than the angular passage 60 so that the ball bearing 62 will not enter the vertical passage 68. The spring 64 has enlarged coils at an end near said base that are larger than the inside of the angular passage. These coils exert pressure on the inside of the angular passage to retain the spring within the passage. A cable manager 70 is inserted into a lower end of the inner cylinder 54 and a spindle 72 is inserted into the upper end of the inner cylinder 54. The spindle is made from two separate pieces, but could be made from more or fewer pieces. In FIG. 10B, the ball lock joint is in a locked position.

In FIGS. 13 and 14, there are shown perspective views of spindle 72 having a post 74 centrally mounted on a circular base 76. The base 76 has a throughhole 78 extending therethrough. The throughhole 78 is sized and shaped so that it can be aligned with the vertical passage 68 of the housing 50. The post 74 has a tapered portion 80 near a free end 82 thereof. The post and tapered portion are sized to fit within the inner cylinder 54 of the housing 50 (not shown in FIGS. 13 and 14) so that the tapered portion is located opposite the opening 66 when the post 74 has been inserted as far as possible into the first cylinder 54 so that the base 76 rests against an upper surface of the web 58. As the spindle is being inserted, the force exerted on the spindle will cause the ball bearing 62 to move against the pressure of the spring 54 out of the opening 66 and so that it is fully within the angular passage 60. When the free end 82 of the spindle 72 passes by the opening 66 and the tapered portion 80 is adjacent to the opening 66, the force from the spindle will be removed the spring 64 will cause the ball bearing 62 to again protrude into the inner cylinder 54 through the opening 66. The protruding ball bearing 62 will lock the spindle in position within the housing 50 and prevent the spindle from being removed. Even though the spindle is locked within the housing 50, it can still rotate easily about its longitudinal axis within the housing 50. By aligning the throughhole 78 with the vertical passage 68 and inserting a rod through the throughhole and into the vertical passage 68 and ultimately into the angular passage 60, an external force can be exerted on the ball bearing 62 to force the ball bearing to move completely out of the opening 66 and fully into the angular passage 60. In this position, the ball lock joint formed by the spindle and housing is in the unlocked position and the spindle can easily be removed from the housing 50.

In FIG. 15, there is shown an exploded version of a ball lock joint 84. It can be seen that there are two bushings 86, 88 and two collars 90, 92 located between the spindle 72 and the housing 50. When the ball lock joint 84 is used to lock two support arms (not shown in FIG. 15) together, the bushing 88 is placed onto the housing 50 and the housing 50 is inserted into the opening in one end of one of the two support arms. The collar 92 is then placed on the housing 50 and lowered to fit in the opening. The collar 90 is then placed on the housing 50 and placed in contact with the collar 92. The collars 90, 92 are identical to one another and have legs 94 thereon. The collars are inverted relative to one another so that the two sets of legs interlock. Next, the other arm of the two arms (not shown in FIG. 15) is placed on the housing 50 and the bushing 86 is placed onto the housing so to fit against the opening of the other arm. The spindle 72 is then placed into the housing 50 to lock the two arms together. In the locked position, the arms can still be rotated relative to one another. The bushings 86, 88 are identical to one another and are inverted relative to one another. The bushings 86, 88 and collars 90, 92 are preferably made from a plastic material and they prevent the metal arms from directly contacting the metal housing 50. The same reference numerals are used in FIG. 15 as those used in FIGS. 11 and 13 to describe those components that are identical.

In FIG. 16, there is shown an exploded view of a second support arm 14. The second support arms 14, 16 and 26 are all identical to one another. Support arm 14 has a collar 98 located at one end thereof. The collar 98 has two side members 100 that pivotally connect into a body 102, which in turn connects into the monitor attachment 28. The monitor attachment can tilt in all directions. Washers 97, 99 and bolts 101, 103 hold the components together. In FIGS. 17 and 18, there is shown an exploded side view of two embodiments of the main support 4. The difference between the two embodiments is in the lower portion of the base 32. In the embodiment shown in FIG. 17, the base 32 has a grommet 104 thereon to mount the main support on a horizontal surface. In FIG. 18, the base 32 has a clamp 106 to be used to clamp the main support 4 to a vertical surface. Both of the main supports have a plate 108 located beneath the base 32 and an elongated member 107 with cap 109.

In FIG. 19, there is shown an exploded perspective view of a beam joint 30. The beam joint has a bolt 110, a housing 112, a bushing 86, a collar 90 and a nut 118. When the beam joint 30 is installed on a beam that is the same or similar to the beam 6 (not shown in FIG. 19), the housing 112 is located above the channel 8 (not shown in FIG. 19), of the beam 6 and the bushing 86, the collar 90 and the nut 118 are located beneath the channel 8. Access to interior of the beam 6 is provided along a bottom (not shown) of the beam 6 (not shown in FIG. 19).

In FIGS. 20 and 21, there are shown side and front views respectively of a ball lock pin 120 having a top 122, a bottom 124 with rounded corners 128 and a nib 126. The ball locking pin 120 is an alternative to the ball bearing 62 shown in FIG. 10B and can be used in place of the ball bearing. As with the ball bearing, the locking pin 120 must be large enough so that it will not enter the vertical passage 68 (not shown) in FIGS. 20 and 21.

Preferably, the curved body of the first support arms curves in a vertical plane so that one end of the first support arm is located at a different level from another end. The support of the present invention can be arranged in various configurations and is not limited to the configurations shown in the drawings. By a combination of first support arms or first and second support arms numerous configurations can be used with the added advantage of the monitor supports can be located at the same height.

Alternatively, there may be some circumstances when a user does not want to have the monitor supports located at the same height and that result is achievable as well by choosing the combination of first support arms or first and second support arms that provides that result. The first and the second support can be connected to a previous first or second support either from beneath or from above the previous support. For example, in FIG. 3, the first support 42 is connected to the first support 12 from below and the first support 40 is connected to the first support 10 from above. Thus, a user utilizes not only the curvature of the body, but also whether the subsequent support arms are connected above or beneath any previous support arms.

I claim:

1. A support for a plurality of flat monitors comprising a plurality of support arms, at least some of said support arms having a curved body with a top and bottom, a first end and a second end, said ends each having an opening therein to receive a connector, said ends being pivotally connected about any connector located within said ends, said first end being located at a higher level than said second end when said ends are substantially oriented in horizontal planes, said support being capable of supporting all of said flat monitors at an identical height, said support arms being connectable to a main support and to one another, there being sufficient support arms supporting each monitor to support all of said monitors at an identical height.

2. A support as claimed in claim 1 wherein said support arms are connected to said main support and to each other at different levels.

3. A support as claimed in claim 1 wherein there are connectors located at either end of said support arms, at least one of said connectors being a ball lock joint.

4. A support as claimed in claim 1 wherein said support arms are connectable at either end, either above or beneath another support arm.

5. A support as claimed in claim 1 wherein said main support is a horizontal beam with connectors thereon.

6. A support as claimed in claim 1 wherein said main support is vertically oriented.

7. A support as claimed in claim 6 wherein said main support has a cylindrical body and said body is sized to act as a connector to one or more of said support arms.

8. A support as claimed in claim 7 wherein said support arms on said cylindrical body have a releasable lock to hold said arms in a fixed position on said body.

9. A support as claimed in claim 1 wherein said support arms are substantially horizontal.

10. A support as claimed in claim 1 wherein said support arms with a curved body are identical to one another.

11. A support as claimed in claim 10 wherein said support arms with a curved body are first support arms and there are second support arms, said second support arms having a straight body with an opening at one end to receive a connector, each second support arm being pivotal about the connector, said second arms each having another end that has a monitor connector thereon, said monitor connector being tiltable.

12. A support for a plurality of flat monitors comprising a plurality of support arms, said support arms having a first end and a second end, each of said ends having an opening therein to receive a connector, there being a plurality of connectors, at least one of said connectors being a ball lock joint that is sized and shaped to removably fit within any one of said openings, said at least one ball lock joint having a locked position and an unlocked position, at least one of said support arms being pivotal about said at least one ball lock joint when said at least one ball lock joint is in said locked position, said at least one ball lock joint being removable from said end when said at least one ball lock is in said unlocked position.

13. A support as claimed in claim 12 wherein at least some of said support arms have a curved body.

14. A support as claimed in claim 13 wherein said curved body curves in a vertical plane so that one end of said support is located at a different level from another end of said support.

15. A support as claimed in claim 14 wherein said curved support arms are reversible, interchangeable and can be connected to other support arms located above or beneath said ends.

16. A support as claimed in claim 6 wherein there are two curved support arms connected to said vertical body above one another, said curved support arm that is above said other support arm being an upper support arm and said other support arm that is beneath said upper support arm being a lower support arm, there being at least two additional curved support arms, one additional support arm being connected to each of said upper and lower support arms, said additional support arm for said upper support arm being connected beneath said upper support arm and said additional support arm that is connected to said lower support arm being connected above said support arm so that a free end of one of said additional support arms is at a same height as a free end of the other said additional support arms.

17. A method of constructing a support for a plurality of flat monitors, said support having a main support with a plurality of first support arms, said first support arms having a curved body with a first end and a second end, said curved body extending in a vertical plane, said ends each having an opening therein to receive a connector and being capable of being pivotally connected to said connector, there being a plurality of connectors and a plurality of second support arms, said second support arms being straight support arms with monitor attachments at free ends thereof, said method comprising choosing an appropriate combination of first support arms and connectors from said plurality of first arms, second arms and connectors and connecting said support arms to said main support and/or to one another with second support arms being added to said first support arms where necessary to achieve a monitor support for a desired number of monitors having said free ends that are at a desired height.

18. A method as claimed in claim 17 wherein said method includes the steps of choosing and connecting said supports to have said free ends at an identical height for all of said monitors.
